(19) United States
(12) Patent Application Publication
(10) Pub. No.: US 2018/0255139 A1
(43) Pub. Date: Sep. 6, 2018

(54) TERMINAL DEVICE FOR COMMUNICATING USING INTERNET OF THINGS (IOT) MODULE AND DATA COMMUNICATION MODULE AND CORE NETWORK DEVICE

(71) Applicant: Electronics and Telecommunications Research Institute, Daejeon (KR)

(72) Inventors: Dongmyoung Kim, Sejong-si (KR); Jung Soo Park, Daejeon (KR); Younghwan Choi, Daejeon (KR); Yun Chul Choi, Sejong-si (KR)

(73) Assignee: Electronics and Telecommunications Research Institute, Daejeon (KR)

(21) Appl. No.: 15/696,859

(22) Filed: Sep. 6, 2017

(30) Foreign Application Priority Data
Mar. 3, 2017 (KR) 10-2017-0027437

(51) Int. Cl. H04L 29/08; H04W 64/00; H04W 68/02

(52) U.S. Cl. CPC H04L 67/12; H04W 88/02; H04W 68/02; H04W 64/00

(57) ABSTRACT

Disclosed is a core network device and terminal device communicating using an Internet of things (IoT) module and a data communication module, the terminal device including an IoT module, a data communication module, and a controller configured to transmit a preference and a support function of the terminal device to the core network device and perform an optimization function through an interoperation between the IoT module and the data communication module in response to an optimization request from the core network device, the optimization request being based on the support function and the preference.

### CROSS-REFERENCE TO RELATED APPLICATION(S)

This application claims the priority benefit of Korean Patent Application No. 10-2017-0027437 filed on Mar. 3, 2017, in the Korean Intellectual Property Office, the disclosure of which is incorporated herein by reference for all purposes.

### BACKGROUND

### 1. Field

One or more example embodiments relate to a terminal device for communicating using an Internet of things (IoT) module and a data communication module and a core network device.

### 2. Description of Related Art

In 3^{rd} generation partnership project (3GPP), NarrowBand-Internet of things (NB-IoT) technology that performs low-power long-distance IoT communication based on long term evolution (LTE) technology is defined over a physical layer, a media access control (MAC) layer, and an upper network function.

The NB-IoT technology may allow a wide coverage communication with low power and may be used to develop a very low-cost dedicated communication interface module. On the basis of this, a low-lost IoT-dedicated communication interface module has been developed separately from a typical LTE communication interface module.

However, the low-lost IoT-dedicated communication interface module may be used only in an IoT terminal.

### SUMMARY

An aspect provides technology for operating a terminal device including an Internet of things (IoT) terminal and a data communication module at a low power.

Another aspect also provides technology for optimizing a terminal device using an IoT module and a data communication module interoperated with each other.

According to an aspect, there is provided a terminal device including an IoT module, a data communication module, and a controller configured to transmit a preference and a support function of the terminal device to a core network device and perform an optimization function through an interoperation between the IoT module and the data communication module in response to an optimization request of the core network device, wherein the optimization request is a request based on the preference and the support function.

The controller may be configured to activate the data communication module in response to the optimization request, and the data communication module may be configured to be changed from an inactivated status to an activated status by the controller.

The controller is configured to perform at least one of a downlink packet based paging function, a terminal reachability determination updating function, and a position tracking function using the IoT module in response to the optimization request.

In response to the optimization request, the controller may be configured to determine whether an initial signaling for data transmission is to be performed and perform the initial signaling using the IoT module based on a result of the determining.

In response to the optimization request, the controller may be configured to perform small data transmission using the IoT module and perform big data transmission using the data communication module.

In response to the optimization request, the controller may be configured to selectively use the IoT module or the data communication module based on a coverage environment of the terminal device.

When the IoT module is reachable in the coverage environment, the controller may be configured to perform a location update function and a status report function in response to the optimization request.

The controller may be configured to receive at least one management parameter and the optimization request from the core network device, and use the at least one management parameter by allocating the at least one management parameter to the IoT module or the data communication module.

The at least one management parameter may include a first parameter and a second parameter, and the controller may be configured to allocate the first parameter to the IoT module and use the allocated first parameter and allocate the second parameter to the data communication module and use the allocated second parameter.

The at least one management parameter may include one of a parameter associated with tracking area management, a parameter associated with a location update timer, and a parameter associated with a paging and inactive period.

According to another aspect, there is also provided a core network device including an IoT module, a data communication module, and a controller configured to receive a preference and a support function of a terminal device from the terminal device and determine whether to request the terminal device to perform optimization based on the preference and the support function.

The controller may be configured to verify whether the terminal device includes an IoT module and a data communication module based on subscription information stored in a network or the support function, verify whether the terminal device supports an interoperation function, and determine whether to request the optimization.

The controller may be configured to request the terminal device to perform at least one of a downlink packet based paging function, a terminal reachability determination updating function, and a position tracking function using an IoT module.

The controller may be configured to request the terminal device to determine whether an initial signaling for data transmission is to be performed and perform the initial signaling using an IoT module based on a result of the determining.

The controller may be configured to request the terminal device to perform small data transmission using an IoT module and perform big data transmission using a data communication module.

The controller may be configured to request the terminal device to selectively use an IoT module or a data communication module based on a coverage environment of the terminal device.

When the IoT module is reachable in the coverage environment, the controller may be configured to request the terminal device to perform a location update function and a status report function.

The controller may be configured to transmit at least one management parameter and the optimization request to the terminal device and request the terminal device to use the at least one management parameter by allocating the at least one management parameter to an IoT module or a data communication module of the terminal device.

The at least one management parameter may include a first parameter and a second parameter, and the controller may be configured to request the terminal device to allocate the first parameter to the IoT module of the terminal device and allocate the second parameter to the data communication module of the terminal device.

The at least one management parameter may include one of a parameter associated with tracking area management, a parameter associated with a location update timer, and a parameter associated with a paging and inactive period.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is a block diagram illustrating a mobile communication system according to an example embodiment;

FIG. 2 is a block diagram illustrating an example of a terminal device of FIG. 1;

FIG. 3 is a block diagram illustrating an example of a core network device of FIG. 1;

FIG. 4 is a diagram illustrating an example of an operation of the mobile communication system of FIG. 1;

FIG. 5 is a diagram illustrating another example of an operation of the mobile communication system of FIG. 1;

FIG. 6 is a diagram illustrating an example of an operation of determining a transmission module in a core network device of FIG. 5; and

FIG. 7 is a diagram illustrating another example of an operation of determining a transmission module in the core network device of FIG. 5.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent to one of ordinary skill in the art.

Various alterations and modifications may be made to the examples. Here, the examples are not construed as limited to the disclosure and should be understood to include all changes, equivalents, and replacements within the idea and the technical scope of the disclosure.

Terms such as first, second, A, B, (a), (b), and the like may be used herein to describe components. Each of these terminologies is not used to define an essence, order or sequence of a corresponding component but used merely to distinguish the corresponding component from other component(s). For example, a first component may be referred to a second component, and similarly the second component may also be referred to as the first component.

It should be noted that if it is described in the specification that one component is “connected,” “coupled,” or “joined” to another component, a third component may be “connected,” “coupled,” and “joined” between the first and second components, although the first component may be directly connected, coupled or joined to the second component. In addition, it should be noted that if it is described in the specification that one component is “directly connected” or “directly joined” to another component, a third component may not be present therebetween. Likewise, expressions, for example, “between” and “immediately between” and “adjacent to” and “immediately adjacent to” may also be construed as described in the foregoing.

The terminology used herein is for the purpose of describing particular examples only, and is not to be used to limit the disclosure. As used herein, the terms “a,” “an,” and “the” are intended to include the plural forms as well, unless the context clearly indicates otherwise. As used herein, the terms “include, “comprise,” and “have” specify the presence of stated features, numbers, operations, elements, components, and/or combinations thereof, but do not preclude the presence or addition of one or more other features, numbers, operations, elements, components, and/or combinations thereof.

Unless otherwise defined, all terms, including technical and scientific terms, used herein have the same meaning as commonly understood by one of ordinary skill in the art to which this disclosure pertains. Terms, such as those defined in commonly used dictionaries, are to be interpreted as having a meaning that is consistent with their meaning in the context of the relevant art, and are not to be interpreted in an idealized or overly formal sense unless expressly so defined herein.

Hereinafter, some example embodiments will be described with reference to the accompanying drawings. It should be understood, however, that there is no intent to limit this disclosure to the particular example embodiments disclosed. Like numbers refer to like elements throughout the description of the figures.

In the present disclosure, a module may be hardware that may perform a function and an operation for each name explained in the specification, a computer program code that may perform predetermined function and operation, or an electronic recordable medium, for example, a processor and a microprocessor, including a computer program code for performing predetermined function and operation.

Accordingly, the module may indicate a functional and/or structural combination of hardware for performing technical ideas of the present disclosure and/or software for driving the hardware.

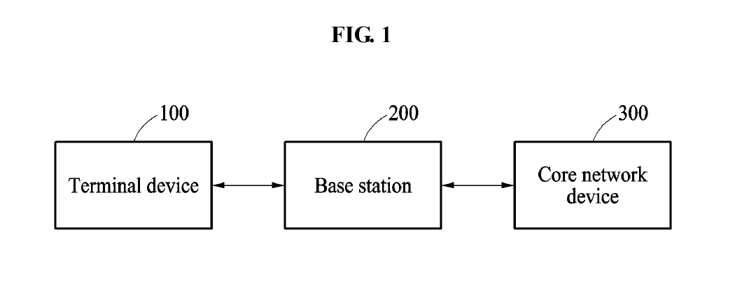

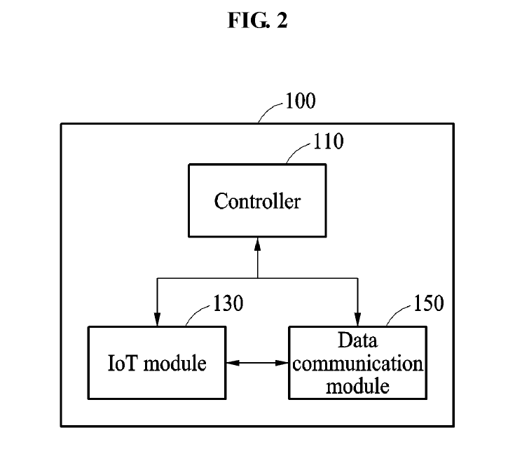

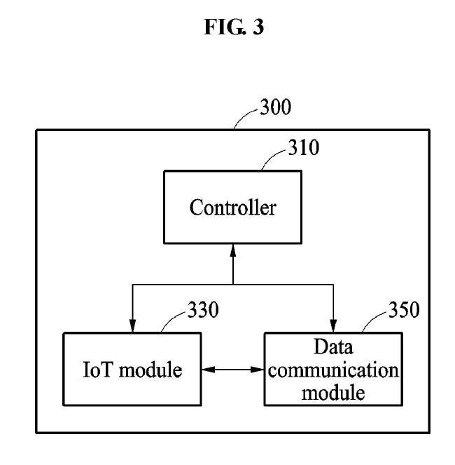

FIG. 1 is a block diagram illustrating a mobile communication system according to an example embodiment, FIG. 2 is a block diagram illustrating an example of a terminal device of FIG. 1, and FIG. 3 is a block diagram illustrating an example of a core network device of FIG. 1.

Referring to FIGS. 1 through 3, a mobile communication system 10 may provide a centralized mobile communication environment. The mobile communication system 10 may include a terminal device 100, a base station 200, and a core network device 300.

The terminal device 100 may communicate with a core network, for example, the core network device 300. In this example, the terminal device 100 may communicate with the core network device 300 via the base station 200. The terminal device 100 may communicate with the core network device 300 directly or indirectly via the base station 200.

The terminal device 100 may be implemented as, for example a laptop computer, a mobile phone, a smartphone, a tablet PC, a mobile internet device (MID), a personal digital assistant (PDA), an enterprise digital assistant (EDA), a digital still camera, a digital video camera, a portable multimedia player (PMP), a personal navigation device or portable navigation device (PND), a handheld console, an e-book, and a smart device. The smart device may be implemented to be, for example, a smart watch and a smart band.

The base station 200 may also be referred to as, for example, a mobile station, a fixed station, a Node B, an evolved node B (eNodeB), a base transceiver system (BTS), and an access point. The terminal device 100 communicating with base stations BS-1 through BS-n may also be referred to as, for example, user equipment (UE), a mobile station (MS), a mobile terminal (MT), a user terminal (UT), a wireless terminal, an access terminal (AT), a subscriber unit, a subscriber station (SS), a wireless device, a wireless communication apparatus, a wireless transmit/receive unit (WTRU), a mobile node, and a mobile.

The terminal device 100 may include a controller 110, an Internet of things (IoT) module 130, and a data communication module 150.

The IoT module 130 may be excellent in power consumption and a coverage environment and thus, may communicate over a wide coverage while consuming a relatively less amount of energy. The IoT module 130 may perform narrowband-Internet of things (NB-IoT). The IoT module 130 may support a low power wide area (LPWA) communication using a mobile communication network.

The IoT module 130 may acknowledge a network situation with a low power and quickly respond to an emergency situation. Also, the IoT module 130 may operate based on a characteristic of an application service, thereby improving a quality of service (QoS).

The IoT module 130 may perform an operation of, for example, registering a location of the terminal device 100 and receiving a paging message.

The data communication module 150 may perform a general data transmission. The data communication module 150 may be in an inactivated status when the terminal device 100 and the core network device 300 access. The data communication module 150 may be changed from the inactivated status to an activated status in response to a command of the controller 110.

The controller 110 may transmit at least one of a preference and a support function of the terminal device 10 to the core network device 300.

The core network device 300 may determine whether to request an optimization based on the at least one of the preference and the support function of the terminal device 100. In response to an optimization request from the core network device 300, the controller 110 may perform various operations. For example, the controller 110 may perform optimization of the IoT module 130 and the data communication module 150 in response to the optimization request from the core network device 300.

The controller 110 may activate the data communication module 150 in response to the optimization request from the core network device 300.

The controller 110 may perform at least one of a downlink packet based paging function, a terminal reachability update function, and a location tracking function using the IoT module 130 in response to the optimization request from the core network device 300.

The controller 110 may determine whether to perform an initial signaling for data transmission in response to the optimization request from the core network device 300. In this example, when the data communication module 150 and the core network device 300 perform the data communication, the controller 110 may not perform the initial signaling. When the controller 110 determines to perform the initial signaling, the controller 110 may use the IoT module 130 to perform the initial signaling. The core network device 300 may collect a signaling traffic through the initial signaling. The core network device 300 may verify a status of the terminal device 100 based on the signaling traffic. The status of the terminal device 100 may include, for example, a location of the terminal device 100 and function information of the terminal device 100.

The controller 110 may perform small data communication using the IoT module 130 and perform big data communication using the data communication module 150 in response to the optimization request from the core network device 300.

The controller 110 may measure a coverage environment of the terminal device 100 in response to the optimization request from the core network device 300. The controller 110 may selectively use the IoT module 130 or the data communication module 150 based on the coverage environment. For example, when only the IoT module 130 is reachable in the coverage environment, the controller 110 may perform the status report function and the location update function of the terminal device 100.

A coverage environment of the IoT module 130 may be different from a coverage environment of the data communication module 150. The IoT module 130 and the data communication module 150 may be simultaneously used while maintaining energy efficiency, and may quickly respond to a shaded area problem.

The controller 110 may receive at least one management parameter and the optimization request from the core network device 300. The controller 110 may allocate the at least one management parameter to the IoT module 130 or the data communication module 150 and use the allocated at least one management parameter.

The at least one management parameter may include, for example, a first parameter and a second parameter. The controller 110 may use the first parameter by allocating the first parameter to the IoT module 130 and use the second parameter by allocating the second parameter to the data communication module 150.

A management parameter may include one of a tracking area management-associated parameter, a location update timer-associated parameter, and a paging and inactive period-associated parameter.

The tracking area management-associated parameter may be a parameter associated with a management of a tracking area (TA). In long term evolution (LTE) communication, a concept of the tracking area may be used. The tracking area may be a subset of a volume of a space in a wireless network in which a predetermined terminal device is to be located. The tracking area may include an area covered by a single base station or a plurality of base stations.

The location update timer-associated parameter may be a parameter associated with an operation of updating location information of the terminal device 100. The controller 110 may update the location information of the terminal device 100 using the location update timer-associated parameter. For example, the controller 110 may perform the location update when a location update timer is expired. The controller 110 may perform the location update and acquire paging information of a paging group including the terminal device 100.

The paging and inactive period-associated parameter may be a parameter associated with a period of paging operation and a period of inactivating operation of the terminal device 100. The controller 110 may set a paging period and/or an inactivating period of the terminal device 100 using the paging and inactive period-associated parameter.

The core network device 300 may include a controller 310, an IoT module 330, and a data communication module 350. Configurations and operations of the IoT module 330 and the data communication module 350 may be substantially the same as configurations and operations of the IoT module 130 and the data communication module 150.

The controller 310 may receive at least one of a preference and a support function from the terminal device 100 and determine whether to request an optimization based on the at least one of the preference and the support function.

The controller 310 may acquire subscription information of the terminal device 100 from a network for example, a subscriber information server of a provider. The subscription information of the terminal device 100 may be stored in the network. Also, the controller 310 may acquire provider policy information from a network, for example, a provider network management server of a provider. The provider policy information may include a provider policy related to a network operation. An operation of acquiring the subscription information and/or the provider policy information may be performed by the controller 310. Also, the subscription information and/or the provider policy information may be acquired through a transmission from a network to the controller 310.

The controller 310 may request the terminal device 100 to perform various operations.

For example, the controller 310 may verify whether the terminal device 100 supports an interoperation function and whether the terminal device 100 includes the IoT module 130 and the data communication module 150 based on the at least one of the subscription information and the support function of the terminal device 100. The controller 310 may determine whether to request the optimization based on a verification result.

The controller 310 may transmit an optimization request to the terminal device 100 based on a determination whether to request the optimization.

The controller 310 may request the terminal device 100 to perform the optimization function of the IoT module 130 and the data communication module 150 in addition to transmitting the optimization request to the terminal device 100.

The controller 310 may request the terminal device 100 to activate the data communication module 150 in addition to transmitting the optimization request to the terminal device 100.

The controller 310 may request the terminal device 100 to perform at least one of a downlink packet based paging function, a terminal reachability determination updating function, and a position tracking function using the IoT module 130 in addition to transmitting the optimization request to the terminal device 100.

The controller 310 may request the terminal device 100 to determine whether to perform an initial signaling for data transmission in addition to transmitting the optimization request to the terminal device 100. In this example, when the data communication module 150 and the core network device 300 perform the data communication, the terminal device 100 may not perform the initial signaling. When the terminal device 100 determines to perform the initial signaling, the terminal device 100 may use the IoT module 130 to perform the initial signaling. The core network device 300 may collect a signaling traffic through the initial signaling. The core network device 300 may verify a status of the terminal device 100 based on the signaling traffic. The status of the terminal device 100 may include, for example, a location of the terminal device 100 and function information of the terminal device 100.

The controller 310 may request the terminal device 100 to perform small data communication using the IoT module 130 and perform big data communication using the data communication module 150 in addition to transmitting the optimization request to the terminal device 100.

The controller 310 may request the terminal device 100 to measure a coverage environment of the terminal device 100 in addition to transmitting the optimization request to the terminal device 100. The terminal device 100 may selectively use the IoT module 130 or the data communication module 150 based on the coverage environment. For example, when only the IoT module 130 is reachable in the coverage environment, the terminal device 100 may perform the status report function and the location update function of the terminal device 100.

The core network device 300 may transmit at least one management parameter to the terminal device 100 in addition to transmitting the optimization request to the terminal device 100. The terminal device 100 may allocate the at least one management parameter to the IoT module 130 or the data communication module 150 and use the allocated at least one management parameter.

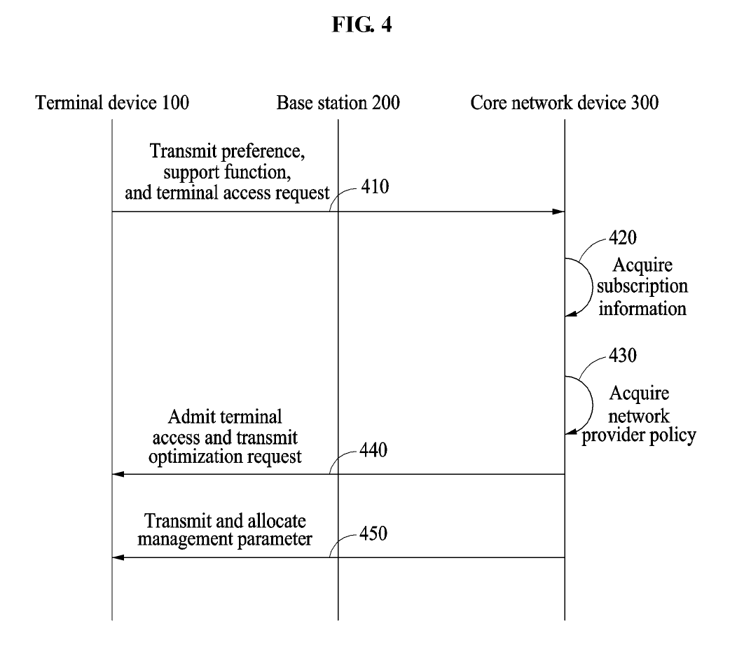

FIG. 4 is a diagram illustrating an example of an operation of the mobile communication system of FIG. 1.

Referring to FIG. 4, when the terminal device 100 communicates with the core network device 300, the terminal device 100 may directly communicate with the core network device 300, or the terminal device 100 indirectly communicate with the core network device 300 via the base station 200.

In operation 410, the terminal device 100 may transmit a preference, a support function, and a terminal access request to the core network device 300. The support function may include whether the terminal device 100 includes a multiple communication module. The multiple communication module may include the IoT module 130 and/or the data communication module 150. The preference may include a preference for utilizing a joint optimization function of the terminal device 100. For example, the terminal device 100 may transmit whether the terminal device 100 includes the multiple communication module and the preference for utilizing the joint optimization function to the core network device 300.

In operation 420, the core network device 300 may acquire subscription information. For example, the core network device 300 may acquire the subscription information of the terminal device 100 from a subscriber information server of a provider. The subscription information may include service information of the provider.

In operation 430, the core network device 300 may acquire a network provider policy. For example, the core network device 300 may acquire a network operation-related provider policy from a provider network management server of the provider.

In operation 440, the core network device 300 may admit a terminal access based on a plurality of pieces of information and transmit an optimization request to the terminal device 100 based on at least one of the subscription information and the provider policy. The optimization request may include an interoperation function of the IoT module and 130 and the data communication module 150.

In operation 450, the core network device 300 may transmit and allocate a management parameter to the terminal device 100. The management parameter may include one of a tracking area management-associated parameter, a location update timer-associated parameter, and a paging and inactive period-associated parameter. The terminal device 100 may allocate the management parameter to the IoT module 130 and/or the data communication module 150.

The terminal device 100 may operate similarly in a low-power mode using the optimization parameter and the management parameter. The terminal device 100 may increase a battery use time with less energy consumption.

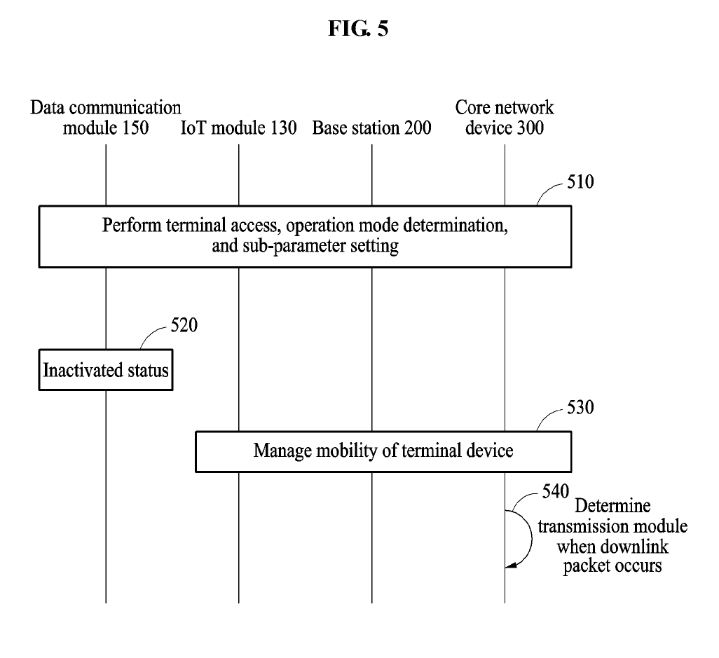

FIG. 5 is a diagram illustrating another example of an operation of the mobile communication system of FIG. 1.

Referring to FIG. 5, in operation 510, the terminal device 100, the base station 200, and the core network device 300 may perform a terminal access, an operation mode determination, and a sub-parameter setting. The terminal access, the operation mode determination, and the sub-parameter setting may be as described in FIG. 4.

In operation 520, the data communication module 150 may be in an inactivated status. The inactivated status of the data communication module 150 may be maintained until a command of the controller 110 is received. The core network device 300 may apply a policy associated with the command of the controller 110 to the terminal device 100. For example, when the core network device 300 requests the terminal device 100 to use a data communication module, the controller 110 may allow the IoT module 130 to transmit a signaling to the data communication module 150. When the signaling is received from the IoT module 130, the data communication module 150 may be changed to an activated status based on the policy.

In operation 530, the core network device 300 may manage a mobility of the terminal device 100 using the IoT module 130. The core network device 300 may perform a terminal managing operation using the IoT module 130. The core network device 300 may perform an operation of, for example, registering a location of the terminal device 100, updating the location of the terminal device 100, and receiving a paging message.

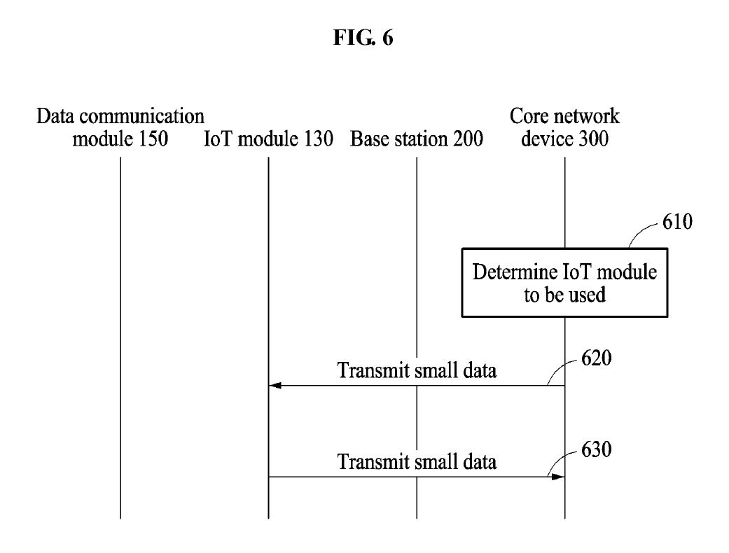

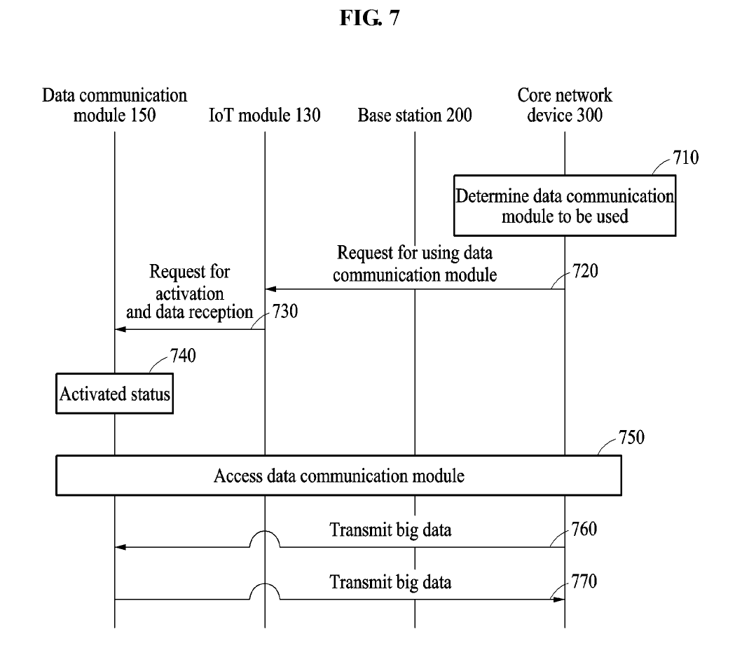

When a downlink packet occurs, the core network device 300 may determine a transmission module in operation 540. For example, the core network device 300 may determine whether to use the IoT module 130 or the data communication module 150 based on a data type. An operation of the core network device 300 determining the transmission module will be described with reference to FIGS. 6 and 7.

FIG. 6 is a diagram illustrating an example of an operation of determining a transmission module in a core network device of FIG. 5.

Referring to FIG. 6, in operation 610, the core network device 300 may determine that the IoT module 130 is to be used based on a data type. For example, when the data type is small data, the core network device 300 may determine that the IoT module 130 is to be used.

In operations 620 and 630, the core network device 300 may transmit and receive data using the IoT module 130.

FIG. 7 is a diagram illustrating another example of an operation of determining a transmission module in the core network device of FIG. 5.

Referring to FIG. 7, in operation 710, the core network device 300 may determine that the data communication module 150 is to be used. For example, when a data type is large data, the core network device 300 may determine that the data communication module 150 is to be used.

In operation 720, the core network device 300 may transmit a request for using the data communication module 150 to the IoT module 130. The core network device 300 may set a policy such that the data communication module 150 is activated based on a signaling of the IoT module 130.

In operation 730, the IoT module 130 may transmit a request for activation and data reception to the data communication module 150. The IoT module 130 may transmit a signaling to the data communication module 150 in response to the request for using the data communication module 150.

In operation 740, the data communication module 150 may be activated in response to an activation request.

In operation 750, the activated data communication module 150 may access the core network device 300. When the data communication module 150 have previously been connected the core network device 300, the data communication module 150 may re-access the core network device 300. The re-access may be performed through a simplified process in comparison to an initial access.

In operation 760 and 770, the core network device 300 may transmit and receive data using the data communication module 150.

The components described in the exemplary embodiments of the present invention may be achieved by hardware components including at least one DSP (Digital Signal Processor), a processor, a controller, an ASIC (Application Specific Integrated Circuit), a programmable logic element such as an FPGA (Field Programmable Gate Array), other electronic devices, and combinations thereof. At least some of the functions or the processes described in the exemplary embodiments of the present invention may be achieved by software, and the software may be recorded on a recording medium. The components, the functions, and the processes described in the exemplary embodiments of the present invention may be achieved by a combination of hardware and software.

The processing device described herein may be implemented using hardware components, software components, and/or a combination thereof. For example, the processing device and the component described herein may be implemented using one or more general-purpose or special purpose computers, such as, for example, a processor, a controller and an arithmetic logic unit (ALU), a digital signal processor, a microcomputer, a field programmable gate array (FPGA), a programmable logic unit (PLU), a microprocessor, or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will be appreciated that a processing device may include multiple processing elements and/or multiple types of processing elements. For example, a processing device may include multiple processors or a processor and a controller. In addition, different processing configurations are possible, such as parallel processors.

The software may include a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. In particular, the software and data may be stored by one or more computer readable recording mediums.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher level code that may be executed by the computer using an interpreter. The above-described devices may be configured to act as one or more software modules in order to perform the operations of the above-described example embodiments, or vice versa.

A number of example embodiments have been described above. Nevertheless, it should be understood that various modifications may be made to these example embodiments. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A terminal device comprising:
an Internet of things (IoT) module;
a data communication module; and
a controller configured to transmit a preference and a support function of the terminal device to a core network device and perform an optimization function through an interoperation between the IoT module and the data communication module in response to an optimization request of the core network device,
wherein the optimization request is a request based on the preference and the support function.

2. The terminal device of claim 1, wherein the controller is configured to activate the data communication module in response to the optimization request, and
the data communication module is configured to be changed from an inactivated status to an activated status by the controller.

3. The terminal device of claim 1, wherein the controller is configured to perform at least one of a downlink packet based paging function, a terminal reachability determination updating function, and a position tracking function using the IoT module in response to the optimization request.

4. The terminal device of claim 1, wherein, in response to the optimization request, the controller is configured to determine whether an initial signaling for data transmission is to be performed and perform the initial signaling using the IoT module based on a result of the determining.

5. The terminal device of claim 1, wherein, in response to the optimization request, the controller is configured to perform small data transmission using the IoT module and perform big data transmission using the data communication module.

6. The terminal device of claim 1, wherein, in response to the optimization request, the controller is configured to selectively use the IoT module or the data communication module based on a coverage environment of the terminal device.

7. The terminal device of claim 6, wherein when the IoT module is reachable in the coverage environment, the controller is configured to perform a location update function and a status report function in response to the optimization request.

8. The terminal device of claim 1, wherein the controller is configured to:
receive at least one management parameter and the optimization request from the core network device; and
use the at least one management parameter by allocating the at least one management parameter to the IoT module or the data communication module.

9. The terminal device of claim 8, wherein the at least one management parameter includes a first parameter and a second parameter, and
the controller is configured to:
allocate the first parameter to the IoT module and use the allocated first parameter; and
allocate the second parameter to the data communication module and use the allocated second parameter.

10. The terminal device of claim 8, wherein the at least one management parameter includes one of:
a parameter associated with tracking area management;
a parameter associated with a location update timer; and
a parameter associated with a paging and inactive period.

11. A core network device comprising:
an Internet of things (IoT) module;
a data communication module; and
a controller configured to receive a preference and a support function of a terminal device from the terminal device and determine whether to request the terminal device to perform optimization based on the preference and the support function.

12. The core network device of claim 11, wherein the controller is configured to verify whether the terminal device includes an IoT module and a data communication module based on subscription information stored in a network or the support function, verify whether the terminal device supports an interoperation function, and determine whether to request the optimization.

13. The core network device of claim 11, wherein the controller is configured to request the terminal device to perform at least one of a downlink packet based paging function, a terminal reachability determination updating function, and a position tracking function using an IoT module.

14. The core network device of claim 11, wherein the controller is configured to request the terminal device to determine whether an initial signaling for data transmission is to be performed and perform the initial signaling using an IoT module based on a result of the determining.

15. The core network device of claim 11, wherein the controller is configured to request the terminal device to perform small data transmission using an IoT module and perform big data transmission using a data communication module.

16. The core network device of claim 11, wherein the controller is configured to request the terminal device to selectively use an IoT module or a data communication module based on a coverage environment of the terminal device.

17. The core network device of claim 16, wherein when the IoT module is reachable in the coverage environment, the controller is configured to request the terminal device to perform a location update function and a status report function.

18. The core network device of claim 11, wherein the controller is configured to:
transmit at least one management parameter and the optimization request to the terminal device; and
request the terminal device to use the at least one management parameter by allocating the at least one management parameter to an IoT module or a data communication module of the terminal device.

19. The core network device of claim 18, wherein the at least one management parameter includes a first parameter and a second parameter, and
the controller is configured to request the terminal device to:
allocate the first parameter to the IoT module of the terminal device; and
allocate the second parameter to the data communication module of the terminal device.

20. The core network device of claim 18, wherein the at least one management parameter includes one of:
a parameter associated with tracking area management;
a parameter associated with a location update timer; and
a parameter associated with a paging and inactive period.
